(19) United States
(12) Patent Application Publication
(10) Pub. No.: US 2005/0064291 A1
(43) Pub. Date: Mar. 24, 2005

(54) Battery and non-aqueous electrolyte secondary battery using the same

(75) Inventors: Toshitada Sato, Osaka-shi (JP); Miyuki Nakai, Izumi-shi (JP); Emiko Igaki, Amagasaki-shi (JP); Yasuhiko Bito, Minamikawachi-gun (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/933,147

(22) Filed: Sep. 2, 2004

(30) Foreign Application Priority Data
Sep. 18, 2003 (JP) 2003-326520

(51) Int. Cl. H01M 4/70; H01M 4/58; H01M 4/40; H01M 4/66

(52) U.S. Cl. 429/233; 429/231.95; 429/245; 429/235; 429/234

(57) ABSTRACT

A negative electrode for a non-aqueous electrolyte secondary battery including a current collector, and an electrode material layer including an electrode material capable of reversibly absorbing and desorbing Li ions is provided. The electrode material includes at least one element selected from the group consisting of Si, Sn and Al; the surface of the current collector is provided with protrusions; the electrode material layer is disposed on the surfaces of the current collector and the protrusions; and the protrusion has a portion facing the surface of the current collector other than a portion that is brought into contact with the current collector. Thus, a negative electrode for a non-aqueous electrolyte battery having high properties such as an energy density, charging/discharging cycle property, and the like, and a non-aqueous electrolyte secondary battery can be provided.

### BACKGROUND OF THE INVENTION

1. Field of the Invention

The present invention relates to negative electrodes for non-aqueous electrolyte secondary batteries and non-aqueous electrolyte secondary batteries using the same.

2. Description of Related Art

Hitherto, research and development for negative electrodes for non-aqueous electrolyte secondary batteries (hereinafter, also referred to as “negative electrodes”) have been carried out. The use of metal lithium for the negative electrode can provide secondary batteries having high output and high energy density. However, it is widely known that branch-shaped dendrites tend to be deposited on the surface of the metal lithium during charging batteries, thereby possibly lowering the charging/discharging efficiency of the batteries or causing an internal short circuit. Therefore, non-aqueous electrolyte secondary batteries using carbon materials such as graphite, which is a material capable of reversibly absorbing and desorbing lithium (Li) ions and being excellent in terms of cycle lifetime and safety, have come into practice. However, the theoretical capacity of the negative electrode made of graphite is about 372 mAh/g, which is smaller than that of metal lithium. Furthermore, batteries having a capacity (350 mAh/g) approaching the theoretical capacity have been come into practice. However, in recent years, as portable devices etc. have been provided with higher functions, batteries with larger capacity have been demanded.

Thus, as an electrode material for negative electrode, much attention has paid to electrode materials formed of an alloy including elements such as silicon (Si), tin (Sn), and the like. Certain kinds of metal (semi-metal) elements such as Si, Sn, and the like, can electrochemically absorb and desorb Li ions. Furthermore, such materials can have greater charging/discharging capacity as compared with that of carbon materials. For example, in the case of Si, the theoretical capacity is about 4199 mAh/g, which is about 11 times as the case of graphite. However, such alloy material including these elements may expand by absorbing Li ions in its crystalline structure. For example, it is thought that when Si absorbs Li ions at maximum, it expands theoretically about 4 times as compared with Si that does not absorb Li ions. Likewise, it is thought that Sn expands theoretically 3.8 times. On the other hand, in the case of graphite, since Li ions are inserted into the interlayer portions of graphite (i.e., intercalation reaction), the expansion rate is such a small as 1.1 times. Therefore, stress that occurs in accordance with the expansion of the alloy-based electrode materials becomes larger than that of graphite.

It is thought that the stress that occurs in conventional materials such as graphite can be absorbed by fixing electrode materials with the use of a binder (a binding agent) such as polyvinylidene fluoride (PVDF), styrene-butadiene copolymer rubber (SBR). However, it is difficult to suppress the stress that occurs in the above-mentioned alloy-based materials only by using these binders, thus possibly causing peeling of the electrode materials from a current collector or reducing the contact point between the electrode materials. The occurrence of such phenomenon may increase the contact resistance between the electrode material and the current collector, as well as between the electrode materials, thus possibly deteriorating the cycle property of the batteries.

In order to solve such problems (in particular, in order to avoid a problem of the increase in the contact resistance between the electrode material and current collector), for example, in JP9-134726A, as shown in FIG. 9, a current collector 100 provided with triangle-shaped protrusions 101 on the surface thereof has been suggested. The protrusions 101 are formed by punching the current collector 100 by using a triangular-shaped punch. At this time, by punching only two sides 101b and 101b with a side 101a unpunched, the protrusion 101 is allowed to protrude. These protrusions 101 prevent the electrode materials from peeling off from the current collector 100.

Furthermore, in JP10-284349A, as shown in FIG. 10, a current collector 110 provided with a protrusion 111 has been suggested. The protrusion 111 penetrates an electrode 112 and the tip portion 111a of the penetrating the protrusion 111 is allowed to be folded toward the surface of the electrode 112. Thus, the electrode 112 is held between a principle surface of the current collector 110 and a tip portion 111a of the protrusion 111 so as to enhance the adhesive property between the current collector 110 and the electrode 112.

However, in the current collector 100 disclosed in JP9-134726A, a through hole 102 produced when the protrusion 101 is punched may possibly fail to suppress the stress accompanied by expansion. On the other hand, in the current collector 110 disclosed in JP10-284349A, since the protrusion 111 penetrates the electrode 112, on the tip portion 111a of the protrusion 111 that penetrates the electrode 112 and folded, branch-shaped dendrites tend to be deposited and the dendrites may penetrate the separator, thereby possibly causing an internal short circuit.

### SUMMARY OF THE INVENTION

The present invention provides negative electrodes for non-aqueous electrolyte secondary batteries that improve the energy density of a battery by using an alloy electrode material and exhibit high property (for example, high charging/discharging cycle property, etc.) by specifying the shape of the surface of a current collector. The present invention also provides a non-aqueous electrolyte secondary battery using the negative electrode.

The negative electrode for a non-aqueous electrolyte secondary battery of the present invention is capable of reversibly absorbing and desorbing Li ions and includes a current collector, and an electrode material layer including an electrode material capable of reversibly absorbing and desorbing Li ions. The electrode material includes at least one element selected from the group consisting of Si, Sn and Al; protrusions are formed on the surface of the current collector; the electrode material layer is disposed on the surfaces of the current collector and the protrusions; and the protrusion has a portion facing the surface of the current collector other than a portion where the protrusion is brought into contact with the current collector.

The non-aqueous electrolyte secondary battery of the present invention includes the negative electrode for a non-aqueous electrolyte secondary battery; a positive electrode capable of reversibly absorbing and desorbing Li ions; and an electrolyte having a Li ion conductivity.

### BRIEF DESCRIPTION OF THE DRAWINGS

FIG. 1 is a schematic cross-sectional view showing an example of a negative electrode for a non-aqueous electrolyte secondary battery of the present invention.

FIG. 2 is a schematic cross-sectional view to explain examples of protrusions formed on a non-aqueous electrolyte secondary battery of the present invention.

FIG. 3 is a schematic cross-sectional view to explain an example of a protrusion formed on a non-aqueous electrolyte secondary battery of the present invention.

FIGS. 4A to 4K are schematic cross-sectional views to explain examples of protrusions formed on a negative electrode for a non-aqueous electrolyte secondary battery of the present invention.

FIG. 5 is a schematic cross-sectional view showing an example of a negative electrode for a non-aqueous electrolyte secondary battery of the present invention.

FIG. 6 is a schematic cross-sectional view showing an example of a non-aqueous electrolyte secondary battery (coin type) of the present invention.

FIG. 7 is a view showing an example of the surface of the current collector produced in Examples.

FIG. 8 is a schematic view showing an example of a non-aqueous electrolyte secondary battery (cylindrical shape) of the present invention.

FIG. 9 is a perspective view showing a conventional current collector.

FIG. 10 is a cross-sectional view showing a conventional current collector.

### DESCRIPTION OF THE PREFERRED EMBODIMENTS

Firstly, the negative electrode for a non-aqueous electrolyte secondary battery (hereinafter, also referred to as “negative electrode”) according to the present invention will be described.

The negative electrode of the present invention includes a current collector and an electrode material layer including an electrode material capable of reversibly absorbing and desorbing Li ions. The electrode material includes at least one element selected from Si, Sn and Al. Thus, the negative electrode can absorb and desorb Li ions reversibly. Furthermore, a negative electrode with a higher-capacity (higher-energy density) can be achieved as compared with the case where carbon materials such as graphite that is a conventional material for a negative electrode is used for an electrode material.

Furthermore, in the negative electrode of the present invention, protrusions are formed on the current collector, and the electrode material layer is disposed on the surface of the current collector. Thus, since the protrusion is embedded in the electrode material layer, an internal short-circuit can be prevented. Furthermore, the protrusion has a portion facing the surface of the current collector other than a portion that is brought into contact with the current collector. This makes it possible to prevent the electrode material from peeling off from the current collector when the electrode material is expanded.

The shape of the protrusion may be a zigzag shape, an undulated shape or a pile shape. In this case, a negative electrode with high charging/discharging cycle property can be achieved. Furthermore, the protrusion itself may have a protrusion on the surface thereof. More specific examples of the protrusions will be described below.

Electrode materials for the negative electrode of the present invention includes at least one element selected from Si, Sn and Al. As mentioned above, such electrode materials occasionally may expand when absorbing Li ions, thus possibly generating a large stress. Since the stress works so as to push away the electrode materials from each other or to push away the current collector, peeling may occur between the electrode material and the current collector and between the electrode materials. The occurrence of the peeling may increase the electrical resistance component, thereby deteriorating the charging/discharging cycle property in the negative electrode. On the contrary, in the negative electrode of the present invention, with the protrusions formed on the surface of the current collector, the peeling of the electrode materials can be suppressed. Therefore, a negative electrode with high charging/discharging cycle property can be achieved.

Furthermore, when a protrusion has conductivity (for example, a protrusion is formed of the same material as that of the current collector), the protrusion can play a role as a current collector. Therefore, the area of the surface in which the electrode material is brought into contact with the current collector can be increased. Furthermore, the electrode material pushed away due to the expansion accompanied with the absorption of Li ions can be brought into contact with the protrusion (i.e., current collector) again. Therefore, a negative electrode with lower electric resistance can be achieved. Furthermore, also in the case where charging and discharging are repeated, it is possible to suppress the increase in the electric resistance component.

Next, the protrusion of the negative electrode of the present invention will be described. The shape of the protrusion may be determined arbitrarily in accordance with the properties of the necessary negative electrode as long as it has a portion facing the surface of the current collector other than the portion that is brought into contact with the current collector. For example, the protrusion has a portion whose cross-sectional area cut in the direction parallel to the surface of the current collector exceeds an area of a portion that is brought into contact with the current collector.

More specifically, the protrusion may have a column portion linked to the surface of the current collector and a covering portion linked to the end opposite to the current collector. The covering portion has a portion whose cross-sectional area cut in the direction parallel to the surface of the current collector exceeds the cross-sectional area of the column portion (i.e., the area of the portion that is brought into contact with the current collector) cut in the direction parallel to the surface of the current collector. Furthermore, in the case of the above-mentioned configuration, a protrusion may include one such covering portion or may include a plurality of covering portions. In the case where a plurality of covering portions are included, the above-mentioned effect can be obtained securely.

Specific examples of the shapes of protrusions, when seen as a cross-sectional view cut in the direction perpendicular to the surface of the current collector, include a mushroom shape, an umbrella shape, a nail head shape, a laterally-facing L-shape, a reverse J-shape, a hook shape, a T-shape, a Y-shape, a screw shape, a cauliflower shape and a pile shape, and the like.

The average height of the protrusion from the surface of the current collector is not particularly limited. For example, with respect to the thickness of the electrode material layer, the height may be in the range from 15% or more and 75% or less, and preferably in the range from 35% or more and 75% or less. When the average height of the protrusion with respect to the thickness of the electrode material layer is less than 15%, the effect of suppressing the expansion of the electrode material layer and peeling of the electrode material may be reduced. Furthermore, the specific average height of the protrusion may be, for example, 1 μm or more and 100 μm or less, and preferably in the range form 5 μm or more and 50 μm or less. Furthermore, the maximum height of the protrusion is not particularly limited, for example, it may be 95% or less with respect to the thickness of the electrode material layer. When the maximum height of the protrusion is more than 95% with respect to the thickness of the electrode material layer, the protrusion may be exposed to the surface of the electrode materially layer, thus damaging the separator.

The maximum width (maximum width with respect to the direction parallel to the surface of the current collector) of the protrusion may be 0.1 μm or more and 30 μm or less and preferably 1 μm or more and 10 μm or less. When the maximum width is less than 0.1 μm, the protrusion may be deformed due to the stress accompanied by the expansion of the electrode material. On the contrary, when the maximum width is more than 30 μm, the volume ratio of the protrusion occupied in the negative electrode becomes too large, thus making it difficult for the negative electrode to have a high capacity.

The number of protrusions formed on the surface of the current collector is not particularly limited. For example, 10 or more and 10000 or less protrusions may be formed for 1 cm² surface of the current collector. Furthermore, protrusions may be formed on one main surface of the current collector or may be both front and rear surfaces of the current collector. Protrusions may not necessarily be formed on the entire surface of the current collector but they may be formed only on a necessary portion.

Materials and structures of the protrusions are not particularly limited. For example, the protrusions may include metal particles. When the protrusion includes metal particles, for example, a plurality of metal particles are connected to each other or connected to the surface of the current collector, to thus form protrusions. “Connect” herein denotes a state in which metal particles are brought into contact with each other stably on the interface so as to form an intermetallic compound or a solid soluble phase. Such protrusions can be formed by a flame coating method of spraying metal particles to the surface of the current collector at high temperature, by coating a slurry including metal particles onto the current collector and firing in a non-oxidizing atmosphere, or the like. Note here that an example of method for forming the aforementioned various shaped protrusions includes a method of carrying out electroplating, chemical etching, and the like after carrying out the above-mentioned means.

As materials of metal particles, for example, Cu, Ni, Ti or an alloy thereof may be used and may be the same materials as those of the current collector. The average particle size of the metal particles may be, for example, 0.1 μm or more and 10 μm or more. With such protrusions, the protrusions have a conductive property and can increase the area in which the electrode material and protrusion are brought into contact with each other. Therefore, it is possible to obtain the same effect as the case where the contact area between electrode material and the current collector is increased. Furthermore, since fine gaps can be formed between the metal particles, electrolytes easily can be dispersed into the inside of the electrode material, thereby improving the discharging property. Note here that when the average particle size of the metallic particles is less than 0.1 μm, the size of the metallic particles is so small that they are coagulated easily, thus possibly making it difficult to form fine gaps. On the contrary, when the size of the metallic particles is larger than 10 μm, the metallic particles may be larger than the electrode material. In this case, it is difficult to increase the contact area between the metallic material and the protrusion.

The protrusion may include metallic fibers. When the protrusion includes metallic fibers, since the protrusion can be provided with fine gaps between fibers, it is possible to make it easy to disperse electrolyte into the inside of the electrode material layer. Furthermore, since the protrusion has a conductive property and the contacting area between the electrode material and the protrusion can be increased, the same effect can be obtained as in the case where the contacting area between the electrode material and the current collector is made larger. The average value of the fiber diameter of the metallic fiber may be, for example, 0.1 μm or more and 5 μm or less, and preferably 0.3 μm or more and 2 μm or less. When the fiber diameter is less than 0.1 μm, the protrusion may be deformed due to the stress accompanied by the expansion of the electrode material. On the contrary, when the maximum width is more than 5 μm, the volume ratio of the protrusion occupied in the negative electrode becomes too large, thus making it difficult for the negative electrode to have high capacity.

As materials of metal fibers, for example, Cu, Ni, stainless steel or an alloy thereof may be used and may be the same materials as those of current collector. When the materials of the metallic fibers are the same materials as those of the current collector, the current collector include a metallic fibers and the protrusions may have a pile shape formed by raising the metallic fibers. Among all, it is preferable that the protrusion has a pile shape in which the end portion of the metallic fiber is connected to the surface of the current collector or to another metallic fiber. In this case, it is possible to further increase the contact area between the electrode material and the protrusion. Thus, it is possible to suppress the peeling of the electrode materials, and to suppress the increase in the electric resistance component. Note here that when the protrusion has a pile shape as mentioned above, the average height of the protrusion is preferably 3 μm or more 100 μm or less.

The surface of the protrusion and the current collector may include, for example, at least one element selected from the group consisting of Cu, Ni and Ti. A material for the entire current collector is not particularly limited as long as it does not react with Li in the potential of the negative electrode (in the range from about 0V to 1.5V with respect to Li) and is excellent in conductivity. From the viewpoint of cost, Cu or Ni are preferably used.

Furthermore, the interior of the current collector may not include metal elements mentioned above. For example, an example of a current collector includes a current collector formed of a macromolecular film and a conductor layer, wherein the surface of the macromolecular film is provided with protrusions and the conductor layer is formed along the surface shape of the macromolecular film. The macromolecular film is not particularly limited, however, from the viewpoint of the cost, polyolefin such as polypropylene or polyethylene is preferred.

Furthermore, in the above-mentioned configuration, it is preferable that the conductor layer is formed of at least one element selected from the group consisting of Cu, Ni and Ti. From the viewpoint of the cost, Cu or Ni is preferably used. Furthermore, the method for forming the conductor layer on the macromolecular film includes attaching at least one element selected from the group consisting of Cu, Ni and Ti by electroless deposition, a CVD method, an evaporation method or the like. Among them, from the viewpoint of the cost and because it is possible to form a conductor layer uniformly to a large-area portion, the electroless deposition is preferred.

Then, an electrode material and an electrode material layer will be described. The electrode materials are not particularly limited as long as they can absorb and desorb Li ions reversibly, and include at least one element selected from Si, Sn and Al. For example, an alloy (including a solid soluble material, and an intermetallic compound) including at least one element selected from Si, Sn and Al may be used. In the case where Si is included in the electrode material, the content of Si in the electrode material preferably is 50 mass % or more. In the case where Al is included in the electrode material, the content of Al in the electrode material preferably is 50 mass % or more. In the case where Sn is included in the electrode material, the content of Sn in the electrode material preferably is 35 mass % or more. The “electrode material” is used herein so as to intend to mean “negative electrode active material.”

The electrode material further may include a transition metal element. Among all, it is preferable that transition metal element includes at least one element selected from the group consisting of Ti, Zr, Fe, Co, Ni and Cu. Elements such as Si, Sn and Al may expand when absorbing lithium, however, if at that time, the transition metal element that is not electrochemically reacted with Li coexists in the particles of the electrode material, it is possible to suppress the destruction of particles (particle breaking). When the particle breaking is suppressed, a battery property such as charging/discharging cycle property is improved. This is because when the particle breaking occurs, the reacting area is increased, thereby possibly increasing the resistance because the surface of the electrode material is covered by the deformation reaction of the electrolyte. The contact point between the electrode materials in the broken region reduces as compared with that before broken (before broken, the entire surface is a contact surface), therefore, this may be a factor for increasing the resistance. Since such an increase in the resistance of electrode material (i.e., electrode) causes a reduction in the electric current that can be taken out from the electric battery or ununiformity of a chemical reaction inside the battery, it may be a great factor for reducing the property of the battery. Note here that the sufficient content of the transition metal element is about 3 mass % to 50 mass % with respect to, for example, Si and Al. Furthermore, the sufficient content is about 5 mass % to 65 mass % with respect to, for example, Sn. The content in these ranges enables both high capacity and charging/discharging cycle property to be achieved.

The electrode material may have a plurality of phases. Among them, a state in which an intermetallic compound of at least one element selected from the group consisting of Si, Sn and Al and the transition metal element is dispersed is preferred. In such a state, a connecting strength at the interface between a phase that absorbs Li ions and a phase that does not absorb Li ions can be improved. If the connecting strength at the interface is improved, it is possible to further suppress the above-mentioned particle breaking.

The electrode material may be in at least one state selected from a low-crystalline state or an amorphous state. Herein, the low-crystalline state means a state in which when an X-ray diffraction determination (XRD) of the electrode material is carried out using, for example, CuKα radiation, a crystalline diffraction peak based on the electrode material is observed in the resultant diffraction curve (diffraction angle 2θ-diffraction intensity profile) and the half width of the diffraction peak where the most intensive diffraction intensity is 0.6° or more. Furthermore, the amorphous state means a state in which no diffraction peak based on the electrode material is observed in, for example, the resultant diffraction curve and a broad scattering band that has an apex in the range in which 2θ is in the range from 20° to 40° can be observed. In such an electrode material, also in absorbing and desorbing Li ions, the structure of the electrode material easily can be changed and expansion and contraction can be carried out smoothly. Therefore, it is possible to suppress the aforementioned particle breaking.

The electrode material may have a powder form. When the electrode material has a powder form, the maximum particle size may be, for example, 0.01 μm or more 45 μm or less, preferably 0.1 μm or more and 32 μm or less, and among them, particularly preferably, 1 μm or more and 20 μm or less. In the electrode material having the maximum particle size of more than 45 μm, the particle size is too large relative to the protrusion, so that the protrusion may not suppress the stress accompanied by the expansion of the electrode material.

When the electrode material is in a powder form, the production method thereof is not particularly limited and general production methods for the electrode material may be used. Among them, by using a quenching process such as a roll quenching process, an atomization method, and a strip casting method, as well as a solid phase synthesis such as a mechanical alloying process, a mechanical milling process and a mechanical gliding process, electrode materials that are in a low crystalline state or an amorphous state can easily be obtained.

When the electrode material is in a powder form, the electrode material layer may include a conductive agent, a binder or the like in addition to the electrode material. In this case, for forming an electrode material layer on the current collector and the protrusion, a general method including: preparing an electrode material mixture containing an electrode material, a conductive agent, a binder, and the like; coating it on the protrusion; and drying thereof may be employed.

The conductive agent is not particularly limited as long as it is a conductive material and generally used material may be used. Examples of the conductive agent include carbon materials such as carbon black, acetylene black, ketjen black (manufactured by AKZO) and graphite; or metal powder materials including Cu, Ti, Ni, etc.

The binder is not particularly limited as long as it functions for binding a current collector and an electrode material or binding between electrode materials and does not react electrochemically in an operating potential of a negative electrode (or if it reacts, it does not adversely affect the electrode material). Examples of the binder material include styrene-butadiene copolymer rubber material, polyacrylic acid, polyvinyl alcohol, polyvinylidene fluoride, etc.

When the above-mentioned electrode material mixture is prepared, a thickener may be included for the purpose of adjusting the viscosity of the slurry electrode material mixture. As the thickener, when the solvent of the electrode material mixture is water, for example, celluloses such as carboxymethyl-cellulose (CMC) or methyl-cellulose (MC) may be used; and when the solvent is an organic solvent, for example, a hydrocarbon compound may be used. Besides, materials that do not react electrochemically in an operating potential of a negative electrode (or if they react, they do not adversely affect the electrode material) may be used. Furthermore, when water is used as a solvent mixture, for the purpose of adjusting pH of the mixture, bubbling of carbon dioxide may be carried out or pH adjusting material may be added.

Furthermore, the electrode material layer may be adjusted so as to have an arbitrary density by rolling by the use of a roller, etc. after the above-mentioned coating and drying. Furthermore, it is possible to suppress the increase in the electrical resistance by increasing the contacting area between the electrode material and the current collector by rolling.

The density of the electrode material layer when the electrode material is in a powder state may be, for example, 10 volume % or more and 80 volume % or less when it is expressed as porosity. The porosity herein denotes a value that is calculated from the following formula:
(1−σ₂/σ₁)×100,
where σ₁ is a value calculated from the true density of the electrode material, a conductive agent, a binder and other additives (when the value calculated provided no pores are present) and σ₂ is the actual density of the electrode material layer. Note here that the above-mentioned range of the porosity can be applied to positive electrode materials of a positive electrode.

The electrode material may be in a form of a thin film. In this case, for example, the electrode material is a thin film formed on the current collector and protrusion and may be used as an electrode material layer as it is. The thickness of the electrode material (electrode material layer) is, for example, 0.1 μm or more and 10 μm or less and preferably 0.5 μm or more and 7.5 μm or less. The method for producing such electrode materials (electrode material layer) is not particularly limited. For example, a thin film electrode can be produced by a sputtering method, a chemical vapor deposition method (CVD), a vacuum evaporation method, a plating method, etc. Furthermore, the above-mentioned quenching method or solid phase synthesis may be used in combination thereof. Note here that the electrode material layer may include a material other than an electrode material. For example, H, Sb, P, Ge, B, N, etc. may be included.

Then, the non-aqueous electrolyte secondary battery (hereinafter, which is also referred to as “secondary battery”) according to the present invention will be described. The secondary battery of the present invention includes the above-mentioned negative electrode, a positive electrode capable of reversibly absorbing and desorbing Li ions, and an electrolyte having Li ion conductivity. By providing a secondary battery with such a configuration, the secondary battery having high properties such as an energy density and charging/discharging cycle property, etc. can be obtained.

The shape of the secondary battery is not particularly limited. An example of the shape includes a coin type battery produced by laminating a positive electrode and a negative electrode with a separator interposed therebetween, and sealing the entire battery with gascket; and a cylindrical type battery produced by laminating a positive electrode and a negative electrode with a separator interposed therebetween; winding the laminated product; and housing it into a battery case together with an electrolyte.

For the positive electrode, positive electrode generally used for non-aqueous electrolyte secondary battery may be used. For example, a positive electrode material can be formed by attaching an electrode material mixture including a positive electrode material (an active material of the positive electrode) capable of reversibly absorbing and desorbing Li ions, a conductive agent, a binder, and the like to the surface of the positive electrode current collector.

The positive electrode material is not particularly limited as long as it has electropositive potential with respect to Li and can absorb and desorb Li ions reversibly. For example, it may be a composite metal oxide of Li and transition metal element. Such material has an electropositive potential (about 4 to 3 V) and can react with Li ions extremely reversibly. The composite metal oxide may be a compound expressed by the chemical formula LiMO₂ (wherein, M denotes at least one element selected from the group consisting of Co, Ni, Mn, Fe, Al, Mg and Ti).

For the conductive agent used for the positive electrode, for example, carbon materials such as carbon black, acetylene black, ketjen black, graphite, and the like may be used. Besides, materials that are excellent in conductivity and do not react electrochemically in an operating potential of a positive electrode (or if they react, they do not adversely affect the electrode material) can be used without being particularly limited.

The binding agent used for the positive electrode has an operation of binding between the current collector and positive electrode material or between the positive electrodes, and materials that do not react electrochemically in an operation potential of a negative electrode (even if it reacts but does not adversely affect the electrode material) may be used.

The electrolyte is not particularly limited as long as it has an ionic conductivity for Li ions. For example, an electrolytic solution in which Li-containing salt is dissolved in a non-aqueous solvent may be used. Preferably, the non-aqueous solvent is a solvent having high-permittivity and low viscosity. In order to satisfy such a condition, a plurality of non-aqueous solvents may be mixed. For example, high permittivity non-aqueous solvents represented by cyclic carbonates such as ethylene carbonate, propylene carbonate, butylene carbonate and vinylene carbonate; and butyl lactones such as γ-butyrolactone may be combined with a low viscosity non-aqueous solvent represented by a chain carbonates such as dimethyl carbonate, ethylmethyl carbonate, diethyl carbonate, and the like.

The Li-containing salt may be any salt that is not decomposed in the voltage range of the general battery operation and includes stable lithium. Examples of such Li-containing salt include LiPF₆, LiBF₄, LiClO₄, LiN(CF₃SO₂)₂, LiC(CF₃SO₂)₃, and the like.

As the electrolyte, other than the above, polymer electrolyte, solid electrolyte, and the like may be used.

As mentioned above, according to the negative electrode for non-aqueous electrolyte secondary batteries and non-aqueous electrolyte secondary battery, properties such as energy density, charging/discharging property can be improved.

(Embodiment)

Hereinafter, the present invention will be described by way of embodiments with reference to drawings. However, the present invention is not necessarily limited to the embodiments described herein. Note here that the same numbers are given to the same parts in the following Embodiments and the same explanation will not be repeated.

(Embodiment 1)

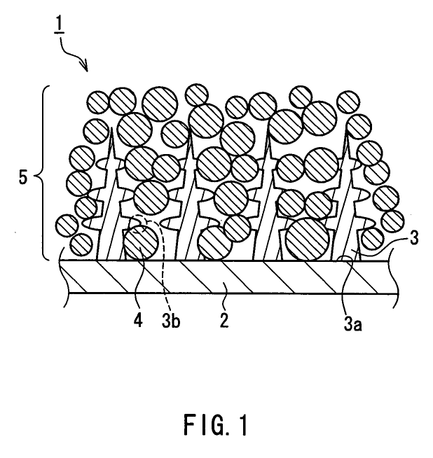

FIG. 1 is a schematic cross-sectional view showing an example of a negative electrode of the present invention. The negative electrode 1 shown in FIG. 1 includes a current collector 2 and an electrode material layer 5 including an electrode material 4 capable of reversibly absorbing and desorbing Li ions. The electrode material 4 includes at least one element selected from Si, Sn and Al. Therefore, the negative electrode 1 can reversibly absorb and desorb Li ions. Furthermore, a negative electrode with a high-capacity (high-energy density) can be achieved as compared with the case where carbon materials such as graphite, i.e., a conventional material for a negative electrode, is used for an electrode material. Note here that FIG. 1 is a schematic diagram and does not reflect the structure of the real negative electrode as it is.

Furthermore, in the negative electrode 1 of the present invention, on the surface of the current collector 2, protrusions 3 are formed. The electrode material layer 5 is disposed on the surfaces of the current collector 2 and the protrusions 3. Thus, the protrusions 3 are embedded in the electrode material layer 5, so that internal short circuit can be prevented. Furthermore, the protrusion 3 has a portion (for example, a portion represented by reference numeral 3b in FIG. 1) facing the surface of the current collector 2 in addition to the portion 3a that is brought into contact with the current collector 2. Thus, for example, the electrode material 4 is held between the portion 3b of the protrusion 3 and the current collector 2, thereby preventing the electrode material 4 from peeling off from the current collector 2 when the electrode material 4 is expanded. Furthermore, for example, it is possible to suppress the tendency of the electrode materials 4 pushed away when the electrode materials 4 is expanded to extend in the direction of the thickness of the negative electrode 1 (the direction perpendicular to the main surface of the current collector 2). When the electrode material 4 extends in the direction of the thickness of the negative electrode 1, the electrode material layer 5 and in turn the negative electrode 1 as a whole are expanded, thereby pressing a separator (not shown) disposed between the negative electrode 1 and a positive electrode (not shown). As a result, the separator cannot hold an electrolyte. At worst, the separator might be broken. Therefore, by providing the negative electrode 1 on which the above-mentioned protrusion 3 is formed on the current collector 2, for example, it is also possible to achieve a negative electrode with high battery property and safety.

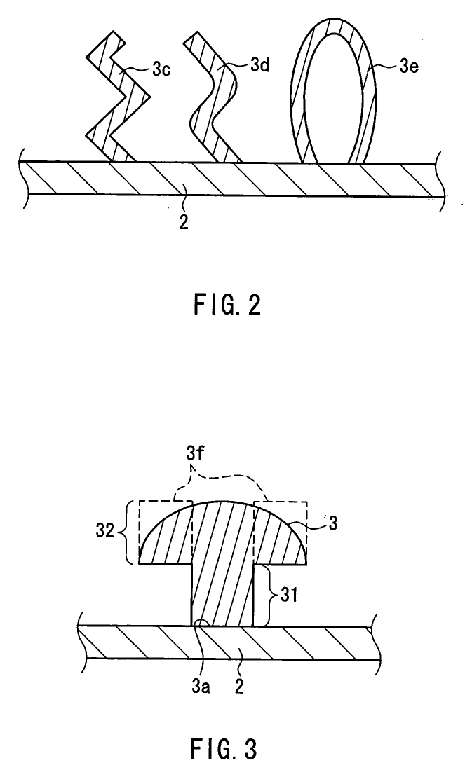

The shape of the protrusion 3 is not particularly limited to the above. As shown in FIG. 2, the shape of the protrusion may have a zigzag shape 3c, an undulated shape 3d and a pile shape 3e. Also in this case, a negative electrode with high charging/discharging cycle property can be achieved.

Furthermore, as shown in FIG. 3, the protrusion 3 may include a column portion 31 linked to the surface of the current collector 2 and a covering portion 32 linked to the end of the column portion 31 opposite the current collector 2. The covering portion 32 includes a portion whose cross-sectional area cut in the direction parallel to the surface of the current collector 2 exceeds an area of the column portion 31 that is brought into contact with the current collector 2 (that is, the area of the contact portion 3a with the current collector 2). In the example shown in FIG. 3, the portion represented by the reference 3f corresponds to this portion. One protrusion 3 may have one such a covering portion 32 or may include a plurality of such covering portions 32. When the protrusion 3 includes a plurality of covering portions 32, the above-mentioned effects can be obtained reliably.

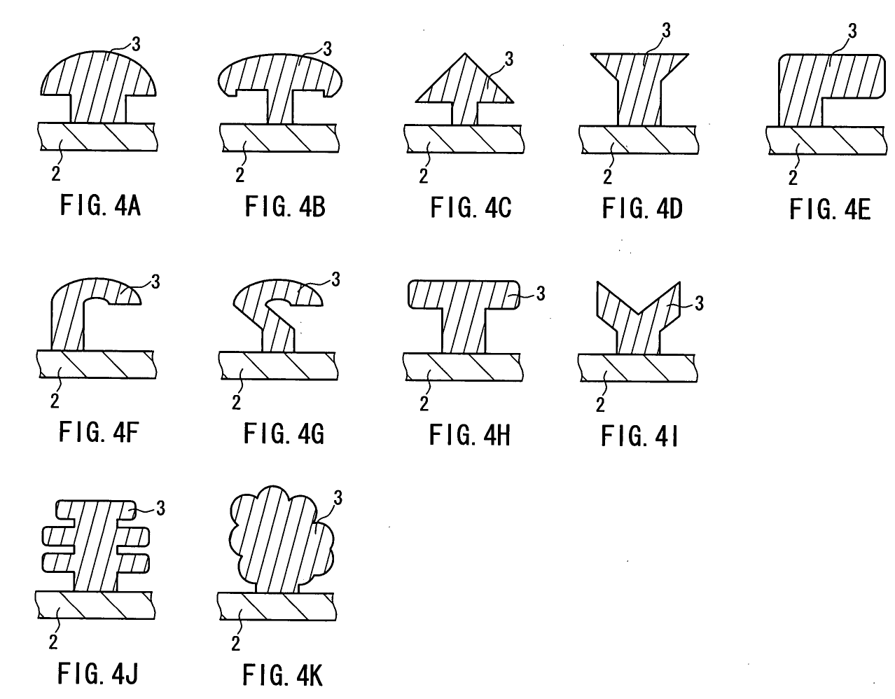

Specific examples of shapes of the protrusion 3 are shown in FIG. 4. FIG. 4 shows cross-sectional schematic views of the protrusions cut in the direction perpendicular to the surface of the current collector 2. FIGS. 4A and 4B show mushroom shapes; FIG. 4C shows an umbrella shape; FIG. 4D shows a nail-head shape; FIG. 4E shows a laterally-facing L-shape; FIG. 4F shows a reverse J-shape; FIG. 4G shows a hook shape; FIG. 4H shows a T-shape; FIG. 4I shows a Y-shape; FIG. 4J shows a screw shape; and FIG. 4K shows a cauliflower shape, respectively.

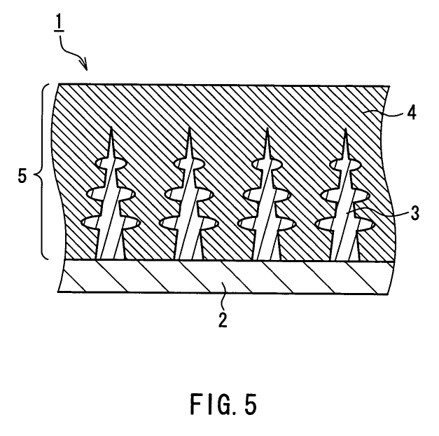

Furthermore, the electrode material 4 may be a form of a thin film. In this case, for example, as shown in FIG. 5, the electrode material 4 is a thin film formed on the current corrector 2 and the protrusion 3 and can be made into an electrode material layer 5 as it is.

(Embodiment 2)

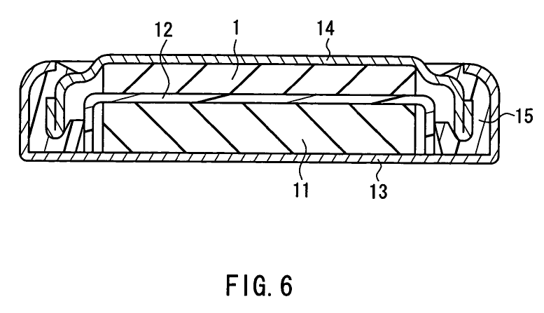

Next, one example of a secondary battery of the present invention will be described. FIG. 6 is a schematic cross-sectional view showing a coin type battery that is one example of the secondary battery of the present invention. In the battery shown in FIG. 6, a positive electrode 11 and a negative electrode 1 are laminated with a separator 12 interposed therebetween. Furthermore, the positive electrode 11 is electrically connected to the positive electrode case 13 that functions also as a positive electrode terminal; and the negative electrode 1 is electrically connected to a sealing plate 14 that also functions as a negative electrode terminal. Furthermore, entire battery is sealed with a gasket 15. Thus, the secondary battery of the present invention has the negative electrode 1 capable of preventing the electrode material from peeling off. Therefore, charging/discharging cycle property can be improved.

### EXAMPLES

Hereinafter, the present invention will be described in more detail according to examples. However, the present invention is not limited to the following examples.

### Examples 1 to 11

Firstly, as electrode materials used for Examples 1 to 11, Ti—Si alloy material was prepared. The alloy material having an average particle size of about 17 μm to 23 μm was obtained by mixing Si particles (purity: 99.9%, average particle size: 20 μm) and Ti particles (purity: 99.99%) at the weight ratio of Si:Ti=60:40, then subjecting the mixture to a gas atomizing method. The XRD profile of the resultant alloy particles has a plurality of peaks showing a crystalline phase. Furthermore, the crystalline size calculated by the Sherrer formula from the half value width of the peak was about 7 μm. Then, the obtained resultant alloy materials were subjected to a mechanical milling (atmosphere of Ar, number of rotation was fixed to 6000 rpm, 3 hours) by Atrita Ball Mill, and thus powder of electrode material was obtained. Note here that the above-mentioned powder was taken out in an atmosphere of Ar without bringing it into contact with air. When a crystalline structure analysis by XRD and observation by a transmission electron microscope (TEM) were carried out with respect to the Ti—Si electrode material powder prepared in this way, it was shown to be an amorphous alloy having at least a Si phase and a phase including an intermetallic compound made of TiSi₂. Furthermore, by the TEM observation, it was confirmed that the powdery electrode material had an average particle size of 2.3 μm and an average value of the crystalline size was about 11 nm. It was confirmed that the amount of oxygen contained in the electrode material was 0.8 weight % by an infrared-absorbing analysis method according to JIS Z 2613.

Next, by using the electrode materials prepared as mentioned above, a negative electrode was produced. 10 g of electrode materials, 0.8 g of fibrous carbon powder (VGCF, manufactured by SHOWA DENKO K.K.) as a conductor; 0.5 g of styrene-butadiene copolymer rubber (manufactured by JSR) were mixed and 10 g of a solution in which CMC was dissolved (concentration: 1 wt. %) then was added to the mixture so as to obtain a slurry of the negative electrode material mixture.

This slurry was coated by a knife-coater on various current collectors shown in Table 1 so that the thickness of the mixture after drying was about 70 μm. After coating, blow-drying was carried out in the atmosphere at 60° C., a negative electrode plate was manufactured. This negative electrode was punched in a diameter of 55 mmΦ so as to obtain a negative electrode to be used for a coin type battery as shown in FIG. 6.

TABLE 1

| | | | Size of protrusion | | |
|---|---|---|---|---|---|
| | | | average | maximum | maximum |
| | | Shape of | height | height | width |
| Sample | Current collector | protrusion | (μm) | (μm) | (μm) |
| Example1 | plated copper foil | mashroom(FIG. 4A) | 35 | 45 | 7 |
| Example2 | plated copper foil | mashroom(FIG. 4B) | 40 | 51 | 12 |
| Example3 | plated copper foil | umbrella(FIG. 4C) | 25 | 34 | 10 |
| Example4 | plated copper foil | nail head(FIG. 4D) | 40 | 48 | 14 |
| Example5 | plated copper foil | laterally facing L(FIG. 4E) | 45 | 55 | 18 |
| Example6 | plated copper foil | reverse J(FIG. 4F) | 28 | 40 | 10 |
| Example7 | plated copper foil | hook(FIG. 4G) | 46 | 58 | 8 |
| Example8 | plated copper foil | T (FIG. 4H) | 47 | 55 | 11 |
| Example9 | plated copper foil | Y(FIG. 4I) | 37 | 47 | 14 |
| Example10 | plated copper foil | screw(FIG. 4J) | 29 | 39 | 11 |
| Example11 | plated copper foil | cauliflower(FIG. 4K) | 32 | 41 | 15 |
| Comparative | rolled copper foil | — | — | — | — |
| Example 1 | | | | | |
| Comparative | electrolytic copper | — | — | — | — |
| Example 2 | foil | | | | |
| Comparative | electrolytic copper | — | — | — | — |
| Example 3 | foil and chemical ethicng | | | | |

For current collectors used in Examples 1 to 11, a plated copper foil formed by electrolytic-plating copper on an electrolytic copper foil having a thickness of 12 μm and surface roughness Ra of 1.8 μm was used. Furthermore, the shape of the protrusion formed on the current collector was formed by controlling conditions for plating pre-treatment, composition of plating liquid, a temperature of plating bath, electrolytic current of the electrolytic plating, electrolytic voltage of the electrolytic plating and condition for an etching treatment after plating.

For example, for producing the current collector used in Example 1, firstly, the above-mentioned electrolytic copper foil was sandwiched from both sides by polyethylene sheet (thickness: 30 μm) provided with through holes having a diameter of 7 μm at intervals of about 20 μm and fixed. This was washed in an alkaline aqueous solution so as to remove a coat on the copper surface exposing portion. Thereafter, this was subjected to an electrolytic plating in a copper sulfate (25 g/L)—sulfuric acid solution containing CU-BRITE VF-II (manufactured by Ebara-Udylite Co., Ltd.) as an additive, under the conditions at the electric current density of 0.5 A/cm² and plating time of 15 minutes, so that a copper column was deposited on the exposing portion of the copper face. Then, the surface of the copper column was provided with Pd catalyst by washing and immersing it in an aqueous solution of Catalyzer PB-318-18 (manufactured by Ebara-Udylite Co., Ltd.) that is a Pd catalyst providing agent (35° C.) for 20 minutes. Then, after washing, the polyethylene sheets were removed from both sides, followed by electroless copper plating in a sulfuric acid aqueous solution (75° C.) containing sodium hypophosphite (20 g/L) and copper sulfate (30 g/L) for 20 minutes so as to obtain a mushroom shaped protrusion.

Furthermore, for producing a current collector used in, for example, Example 11, in the production condition of Example 1, electrolytic plating condition and post treatment condition were changed as follows. Firstly, the electrolytic plating was carried out in a copper sulfate (25 g/L)—sulfuric acid solution containing CU-BRITE 21 (manufactured by Ebara-Udylite Co., Ltd.) as an additive, under conditions at the current density of 1.2 A/cm² and plating time of 15 minutes, so as to grow the copper column to the height of about 45 μm. Subsequently, the copper column was washed with a running secondary distilled water and immersed in an aqueous solution containing 100 mL/L of PD-10 (manufactured by Ebara-Udylite Co., Ltd.) that is an oxide film removing agent so as to remove the surface oxide film, followed by etching treatment in an aqueous solution (50° C.) of ME-20 (manufactured by Ebara-Udylite Co., Ltd.) that is an etching agent for 15 minutes, and thus a cauliflower-shaped protrusion could be obtained. Similarly, also in the other Examples, after copper column was formed, by adjusting a means for providing Pd catalyst, condition of electroless copper plating, condition of etching treatment, and the like, so as to obtain the intended shapes. Note here that the shapes of protrusions, average height of protrusion, maximum height, maximum width were confirmed by observing the surface of the current collector through a scanning electron microscope (SEM).

The thus prepared negative electrode was used for a coin type battery as shown in FIG. 6.

A positive electrode was produced as follows. LiCoO₂ was synthesized by mixing Li₂Co₃ and CoCO₃ at a predetermined molar ratio and heating at 950° C. Furthermore, LiCoO₂ was divided into the size of 100 mesh or less. Then, to 100 g of positive electrode material, 5 g of acetylene black as a conductive agent, 4 g of polyvinylidene fluoride as a binding agent (added as a N-methyl-2-pyrrolidone (NMP) solution containing 4 g of resin component) were added and sufficiently mixed so as to obtain a slurry shaped positive electrode mixture. This slurry was coated on an aluminum core material and dried and further rolled, followed by punching in 50 mmΦ. Thus, a positive electrode was obtained.

The positive electrode and negative electrode produced as mentioned above and a separator made of polyethylene (thickness: 27 μm) were sufficiently impregnated in an electrolytic solution (a solution of LiPF₆ in ethylene carbonate+diethyl carbonate (volume ratio of 1:3)) (concentration: 1 mol/L) and the positive electrode and negative electrode were disposed with a separator interposed therebetween. Thus, a coin type battery as shown in FIG. 6 was produced.

### Comparative Examples 1 to 3

As Comparative Examples 1 to 3, coin type batteries in which only the current collectors are changed with respect to the above-mentioned Examples 1 to 11 were produced. For the current collector in Comparative Example 1, a rolled copper foil having a thickness of 14 μm and surface roughness of 0.02 μm was used. For the current collector in Comparative Example 2, an electrolytic copper foil having a thickness of 11 μm and surface roughness of 0.5 μm was used. Furthermore, for the current collector in Comparative Example 3, a copper foil formed by chemically etching the electrolytic copper foil used in Comparative Example 2 by oxidization treatment so as to have a surface roughness of 2 μm was used.

Property tests for battery capacity and charging/discharging cycle of batteries produced as mentioned above were carried out as follows.

Firstly, a battery was charged with a constant current (charging current: 0.2 C (1 C represents 1 hour-rate current) so that a battery voltage reached 4.05 V. Next, the battery was charged with a constant voltage (charging voltage: 4.05 V) so that a charging current reached 0.01C. Thereafter, the battery was discharged with constant current (0.2 C) so that the battery voltage reached 2.5 V. The battery capacity at this time is shown in Table 2.

From the second time, the battery was charged with a constant current (1C) so that the battery voltage reached 4.05 V and thereafter, charged with constant voltage (charging voltage: 4.05 V) so that the charging current reached 0.05 C, followed by discharging with constant current (discharging current: 1C) so that the battery voltage reached 2.5V, and this cycle was repeated. These charging/discharging cycles were carried out in a temperature-controlled bath whose temperature was set to 20° C. Thus, the battery capacity ratio of the hundredth cycle to the second cycle was calculated, and then the value was multiplied by 100. Then, the thus obtained value was defined as capacity maintaining rate (%). The resultant capacity maintaining rates were shown in Table 2. This shows that as the capacity maintaining rate is close to 100, the charging/discharging cycle property is higher.

Furthermore, at the same time, the expansion rate of the battery produced as mentioned above was evaluated. The measurement of the expansion rate was carried out as follows.

In the first charging state, a battery was diassembled, dividing into a positive electrode, a negative electrode and a separator. The negative electrode was washed with diethyl carbonate and dried at room temperature by blowing air in an atmosphere of dry air. After drying, the thickness of the negative electrode was measured and this measured thickness of the negative electrode was defined as the thickness of initial charging. This thickness was compared with the thickness of the negative electrode before producing the battery and the expansion rate was calculated. The expansion rate was calculated from the formula: (thickness of negative electrode at initial charging)/(thickness of negative electrode before producing battery)×100 (%). The results of the expansion rates are shown in Table 2, respectively.

TABLE 2

| | | capacity | |
|---|---|---|---|
| | battery capacity | maintaining | expansion |
| sample | (mAh) | rate (%) | rate (%) |
| Example 1 | 42 | 91 | 115 |
| Example 2 | 41 | 91 | 114 |
| Example 3 | 42 | 92 | 118 |
| Example 4 | 43 | 89 | 118 |
| Example 5 | 41 | 90 | 113 |
| Example 6 | 43 | 93 | 115 |
| Example 7 | 42 | 93 | 114 |
| Example 8 | 41 | 94 | 116 |
| Example 9 | 42 | 94 | 117 |
| Example 10 | 43 | 97 | 111 |
| Example 11 | 41 | 93 | 113 |
| Comparative Example 1 | 43 | 61 | 186 |
| Comparative Example 2 | 43 | 64 | 179 |
| Comparative Example 3 | 44 | 72 | 178 |

As shown in Table 2, battery capacities of all samples were substantially equal. However, in Comparative Examples 1 to 3, the expansion rate becomes as large as 178% or more and the capacity maintaining rate was as low as 72% or less. Furthermore, in Comparative Examples 1 to 3, the battery after the charging/discharging cycle property was determined was disassembled, peeling was observed between the current collector and the electrode material. On the contrary, in Examples 1 to 11 in which the protrusions were formed on the surface of the current collector, the expansion rate becomes such low as 118% or less and the capacity maintaining rate was such high as 89 or more. Furthermore, in Examples 1 to 11, similarly, the battery after the charging/discharging cycle property was determined was disassembled, no peeling was observed between the current collector and the electrode material.

### Examples 12 to 29 and Comparative Example 4

Furthermore, as to protrusion, by using current collector in which the sizes were changed to those shown in Table 3, coin type batteries (Examples 12 to 29) were produced and the same tests were carried out. Furthermore, as Comparative Example 4, a coin type battery was produced by using a current collector in which protrusions whose maximum height were 80 μm was formed, and then the same tests were carried out. Results are shown in Table 4, respectively.

TABLE 3

| | | size of protrusion | | |
|---|---|---|---|---|
| | | average | maximum | |
| | shape of | height | height | maximum |
| Sample | protrusion | (μm) | (μm) | width (μm) |
| Example 12 | mushroom(FIG. 4A) | 0.1 | 0.2 | 0.6 |
| Example 13 | mushroom(FIG. 4A) | 0.7 | 1 | 2.1 |
| Example 14 | mushroom(FIG. 4A) | 3 | 4 | 0.08 |
| Example 15 | mushroom(FIG. 4A) | 3 | 4 | 0.1 |
| Example 16 | mushroom(FIG. 4A) | 25 | 31 | 30 |
| Example 17 | mushroom(FIG. 4A) | 29 | 35 | 37 |
| Example 18 | screw(FIG. 4J) | 0.3 | 0.5 | 0.5 |
| Example 19 | screw(FIG. 4J) | 0.7 | 1 | 1.9 |
| Example 20 | screw(FIG. 4J) | 2.4 | 3 | 0.04 |
| Example 21 | screw(FIG. 4J) | 3.1 | 4 | 0.1 |
| Example 22 | screw(FIG. 4J) | 29 | 35 | 30 |
| Example 23 | screw(FIG. 4J) | 19 | 29 | 33 |
| Example 24 | cauliflower(FIG. 4K) | 0.5 | 0.7 | 1.2 |
| Example 25 | cauliflower(FIG. 4K) | 0.8 | 1 | 3.5 |
| Example 26 | cauliflower(FIG. 4K) | 4.1 | 5 | 0.08 |
| Example 27 | cauliflower(FIG. 4K) | 3.9 | 5 | 0.1 |
| Example 28 | cauliflower(FIG. 4K) | 21 | 29 | 30 |
| Example 29 | cauliflower(FIG. 4K) | 25 | 30 | 36 |
| Comparative | mushroom(FIG. 4A) | 65 | 80 | 48 |
| Example 4 | | | | |

TABLE 4

| | | capacity | |
|---|---|---|---|
| | battery capacity | maintaining | expansion rate |
| sample | (mAh) | rate (%) | (%) |
| Example 12 | 44 | 62 | 167 |
| Example 13 | 43 | 79 | 126 |
| Example 14 | 43 | 59 | 143 |
| Example 15 | 45 | 77 | 129 |
| Example 16 | 29 | 73 | 122 |
| Example 17 | 15 | 83 | 143 |
| Example 18 | 43 | 60 | 169 |
| Example 19 | 42 | 79 | 130 |
| Example 20 | 44 | 61 | 156 |
| Example 21 | 43 | 80 | 128 |
| Example 22 | 30 | 88 | 120 |
| Example 23 | 9 | 87 | 142 |
| Example 24 | 43 | 60 | 166 |
| Example 25 | 44 | 75 | 119 |
| Example 26 | 42 | 62 | 137 |
| Example 27 | 41 | 80 | 120 |
| Example 28 | 26 | 86 | 119 |
| Example 29 | 7 | 84 | 151 |
| Comparative | — | — | — |
| Example 4 | | | |

As shown in Table 4, in Examples 12 to 29, at least one of the expansion rate and the capacity maintaining rate was improved as compared with those of Comparative Examples 1 to 3 (Table 2). Among all, in the case where the average height of the protrusion was 0.7 μm or more and the maximum width of the protrusion was 30 μm or less, much more improvement was observed. However, in Comparative Example 4 in which a protrusion having a maximum height that is not less than the thickness of the electrode material layer (about 70 μm), internal short circuit occurred and the evaluation could not carried out.

### Examples 30 to 42

As the negative electrodes used in Examples 30 to 42, the same negative electrode as in Example 1 were prepared except that a current collector in which a protrusion made of metallic particles was formed. The average particle size of metallic particle used and the protrusion size are shown in Table 5.

TABLE 5

| | average particle size of | average height | maximum height |
|---|---|---|---|
| | of metal particle | of protrusion | of protrusion |
| Sample | (μm) | (μm) | (μm) |
| Example 30 | 1.5 | 2.1 | 3.5 |
| Example 31 | 1.5 | 10 | 15 |
| Example 32 | 1.5 | 21 | 28 |
| Example 33 | 1.5 | 41 | 49 |
| Example 34 | 0.05 | 0.05 | 0.1 |
| Example 35 | 0.05 | 1.1 | 1.8 |
| Example 36 | 0.1 | 0.3 | 0.4 |
| Example 37 | 0.1 | 1.6 | 1.9 |
| Example 38 | 0.1 | 3.1 | 3.7 |
| Example 39 | 10 | 20 | 29 |
| Example 40 | 10 | 46 | 53 |
| Example 41 | 15 | 30 | 38 |
| Example 42 | 15 | 51 | 60 |

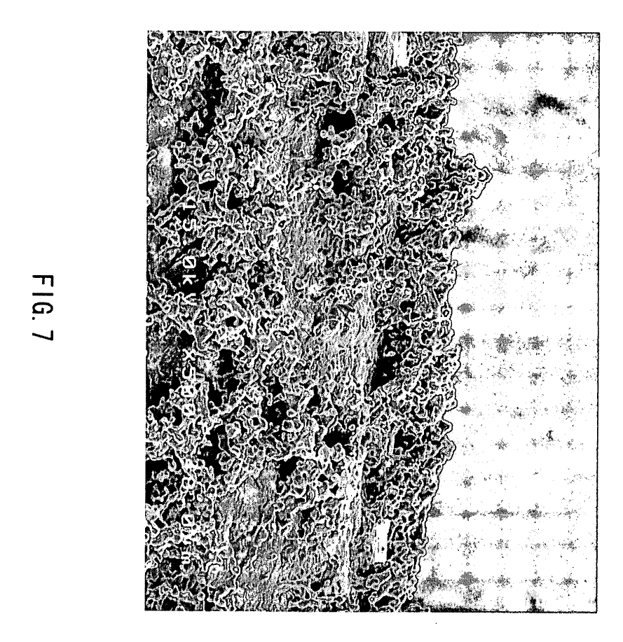

In the current collector of each sample shown in Table 5, on the electrolytic copper foil used in Comparative Example 2, a protrusion to which copper particles (purity: 99.99% or more) were connected was formed. The protrusion was formed as follows. Firstly, in each sample, copper particles having an average particle size shown in Table 5 were mixed with 1 weight % carboxymethyl cellulose solution so that the mixing weight ratio became 1:1 so as to form slurry. Then, this slurry was coated on the electrolytic copper foil used in Comparative Example 2 and dried, followed by firing it in an mixing atmosphere of nitrogen and hydrogen (95 volume %: 5 volume %) at 800° C. Thus, on the surface of the electrolytic copper foil, protrusion formed by connecting a plurality of copper particles to the other copper particles and the surface of the electrolytic copper foil at a plurality of places. Note here that the maximum height of the protrusion was adjusted by a coating gap when the slurry was coated. Furthermore, the average height of the protrusion was adjusted by controlling the particle size of the secondary particles formed by coagulating particles. The control of the secondary particles was carried out by dispersing a slurry of particles having an average particle size shown in Table 5 in a shaker mill and changing the milling time. Note here that the longer the milling time is, the closer the particles size in the slurry becomes the particle size distribution of the particles themselves. The shorter the milling time is, the more easily the particles tend to be coagulated and the particle size of the secondary particles tend to be increased. Examples of SEM observation of the surface of the current collector produced in this way are shown in FIG. 7. In the current collector shown in FIG. 7, cauliflower shaped protrusions were formed.

By using negative electrodes produced as mentioned above, batteries were produced as in Example 1 and the properties were evaluated. The results are shown in Table 6.

TABLE 6

| | | capacity | |
|---|---|---|---|
| | battery capacity | maintaining | expansion |
| sample | (mAh) | rate (%) | rate (%) |
| Example 30 | 43 | 82 | 131 |
| Example 31 | 42 | 88 | 118 |
| Example 32 | 41 | 93 | 112 |
| Example 33 | 38 | 95 | 110 |
| Example 34 | 43 | 55 | 152 |
| Example 35 | 43 | 60 | 149 |
| Example 36 | 43 | 57 | 149 |
| Example 37 | 43 | 79 | 130 |
| Example 38 | 42 | 85 | 122 |
| Example 39 | 39 | 90 | 113 |
| Example 40 | 35 | 91 | 112 |
| Example 41 | 18 | 89 | 110 |
| Example 42 | 10 | 87 | 108 |

As shown in Table 6, in Examples 30 to 42, at least one of the expansion rate and the capacity maintaining rate was improved as compared with those of Comparative Examples 1 to 3 (Table 2). Among all, in the case where the average height of the protrusion was 1 μm or more and the average particle size of the metallic particle (copper particles) was 0.1 μm or more and 10 μm or less, much more improvement was observed.

### Examples 43 to 52

For Examples 43 to 52, the same negative electrodes as in Example 1 were prepared except that a current collector having a pile surface made of only copper was used. The sizes of the protrusion in Examples 43 to 52 are shown in Table 7, respectively.

TABLE 7

| | average fibrous | average height | maximum height |
|---|---|---|---|
| | diameter | of protrusion | of protrusion |
| sample | (μm) | (μm) | (μm) |
| Example 43 | 1.2 | 15 | 21 |
| Example 44 | 0.07 | 1.1 | 2 |
| Example 45 | 0.07 | 6.8 | 8 |
| Example 46 | 0.1 | 1.4 | 2 |
| Example 47 | 0.1 | 5.6 | 10 |
| Example 48 | 0.1 | 12 | 19 |
| Example 49 | 5 | 16 | 20 |
| Example 50 | 5 | 32 | 38 |
| Example 51 | 8 | 14 | 20 |
| Example 52 | 8 | 31 | 36 |

A current collector in each sample shown in Table 7 was produced as follows. Firstly, polyester sheet (NC-2017 manufactured by SUMITOMO 3M Limited) having a pile-shaped surface was degreased and washed with an alkaline aqueous solution and further acid washed with hydrochloric acid. Then, palladium (Pd) catalyst was attached to the surface of the polyester sheet. Then, the polyester sheet was immersed in an electroless copper plating solution so as to cover the surface of the sheet with copper. For example, in Example 43, the sheet was left in the electroless copper plating solution at 60° C. for 30 minutes. As a result of this operation, it was found from the observation of the cross section of the sheet through SEM that copper was attached to the polyester sheet to an average thickness of 1 μm. Similarly, also in the other Examples, by appropriately adjusting the plating conditions, the surface of the polyester sheet was covered with copper. Note here that when the average fiber diameter of the pile is increased or the height of the protrusion is increased, the temperature of plating liquid may be increased and the plating time may be increased. On the contrary, when the average fiber diameter of the pile is reduced, or the height of the protrusion was lowered, the temperature of plating liquid may be reduced and the plating time may be shortened.

On the surface opposite side to the pile side of the polyester sheet on which copper was attached, an electrolytic copper foil (purity: 99.99% or more, thickness: 10 μm, surface roughness: 0.1 μm) was attached, followed by firing in a mixed gas of nitrogen and hydrogen (mixing ratio: 95 volume %: 5 volume %). For example, in Example 43, the firing was carried out at 700° C. for 12 hours. By this firing treatment, a polyester portion was exhausted as a gas, so that a current collector having a pile surface made of only copper could be obtained. Also in the other Examples, firing treatment was carried out while appropriately adjusting firing temperatures, etc. Note here that when the firing treatment was carried out at high temperature (for example 800 to 900° C.), the polyester portion was decomposed in a short time, and thereby the polyester portion shrunk and the height of the protrusion tended to be lowered. On the contrary, the treatment was carried out at low temperature (for example, 600 to 700° C.), the polyester portion was decomposed slowly, and thereby the height before firing can be maintained. By appropriately adjusting the plating condition and firing condition in this way, a current collector of each sample shown in Table 7 was produced.

By using the negative electrodes as mentioned above, batteries were produced as in Example 1 and the properties were evaluated. The results are shown in Table 8.

TABLE 8

| | | capacity | |
|---|---|---|---|
| | battery capacity | maintainng | expansion |
| sample | (mAh) | rate (%) | rate (%) |
| Example 43 | 43 | 91 | 119 |
| Example 44 | 44 | 51 | 160 |
| Example 45 | 43 | 57 | 146 |
| Example 46 | 44 | 50 | 158 |
| Example 47 | 42 | 78 | 128 |
| Example 48 | 42 | 85 | 120 |
| Example 49 | 37 | 93 | 113 |
| Example 50 | 33 | 94 | 111 |
| Example 51 | 15 | 90 | 111 |
| Example 52 | 10 | 92 | 110 |

As shown in Table 8, in Examples 43 to 52, at least one of the expansion rate and the capacity maintaining rate was improved as compared with those of Comparative Examples 1 to 3 (Table 2). Among all, in the case where the average height of the protrusion was 2 μm or more and the average fiber diameter of the pile was 0.1 μm or more and 5 μm or less, much more improvement was observed.

Note here that in Examples 43 to 52, the current collector in which pile shaped protrusions were formed was used. However, the present invention is not limited to this shape. The current collectors in which a zigzag shaped protrusion or a wave shaped protrusion was formed may be used. The zigzag shaped or wave shaped protrusion can be formed by the same method as in the formation method of protrusion in Examples 43 to 52.

### Examples 53 to 59 and Comparative Examples 5 and 6

In Examples 53 to 59, samples in which electrode materials have a thin film shape were produced. For the current collector, as shown in Table 9, those made of copper were used. The protrusion of the current collector in each sample was formed by the same method as mentioned above. Note here that the average particle size of the metallic particles used in Example 56 was 0.8 μm. Furthermore, the average fiber diameter of pile used for Example 57 was 0.3 μm.

TABLE 9

| | | | size of protrusion | | |
|---|---|---|---|---|---|
| | | | average | maximum | maximum |
| | | electrode | height | height | width |
| Sample | Current collector | material | (μm) | (μm) | (μm) |
| Example53 | plating copper foil | Si(6) | 2.1 | 3 | 2.5 |
| | mushroom-shaped protrusion | | | | |
| Example54 | plating copper foil | Si(6) | 3.2 | 4 | 3.2 |
| | screw-shaped protrusion | | | | |
| Example55 | plating copper foil | Si(6) | 2.4 | 3 | 4 |
| | cauliflower-shaped protrusion | | | | |
| Example56 | copper foil having metallic | Si(6) | 2.3 | 3 | — |
| | particle connecting protrusion | | | | |
| Example57 | copper foil having pile | Si(6) | 3.4 | 4 | — |
| | surface | | | | |
| Example58 | plating copper foil | Sn(8) | 3.1 | 4 | 3.2 |
| | screw-shaped protrusion | | | | |
| Example59 | plating copper foil | Al(10) | 3.3 | 4 | 3.2 |
| | screw-shaped protrusion | | | | |
| Comparative | rolled copper foil | Si(6) | — | — | — |
| Example 5 | | | | | |
| Comparative | electrolytic copper foil + chemical | Si(6) | — | — | — |
| Example 6 | etching | | | | |

On the surface of the current collector (and protrusion) in Examples 53 to 57, a film of an electrode material made of Si was formed by a CVD method. In the column of Table 9, numbers in parentheses show the thickness (unit: μm) of the formed thin films. That is to say, in Examples 53 to 57, the film of the electrode material having a thickness of 6 μm was formed. The film forming conditions by a CVD method include: using a mixed gas of silane (raw material gas) and hydrogen (carrier gas) (concentration of silane: 10 volume %); vacuum degree of 400 Pa; and temperature of the current collector of 200° C. (heated by heater). The laminate of the produced current collector and the electrode material was punched in a diameter of 55 mmΦ as in Example 1 so as to obtain a negative electrode used for Examples 53 to 57.

On the surface of the current collector (and protrusion) in Example 58, a Sn layer having a thickness of 8 μm was formed by electrolytic plating. The conditions for electrolytic plating includes: using a fluoroboric Sn plating solution (manufactured by JAPAN PURE CHEMICAL CO., LTD, pH=0.1); bath temperature of 25° C.; electrolytic current of 10 mA/cm²; electrolytic time for 30 minutes. Furthermore, on the surface of the current collector (and protrusion) in Example 59, an Al layer having a thickness of 10 μm was formed by vacuum evaporation method. At this time, Al was evaporated under vacuum condition of 0.004 Pa so as to allow the Al layer to vapor deposited by using an electron beams on the surface of the current collector and the protrusion. Then, each of the resultant laminates was punched out in a diameter of 55 mmΦ so as to obtain a negative electrode used for Examples 58 and 59.

Furthermore, as negative electrodes used for Comparative Examples 5 and 6, the same negative electrodes as those in Examples 53 to 57 except that the current collectors as those in Comparative Examples 1 and 3 were used.

By using negative electrodes produced as mentioned above, batteries were produced as in Example 1, the properties thereof were evaluated. The results were shown in Table 10, respectively.

TABLE 10

| | | Capacity | |
|---|---|---|---|
| | battery capacity | maintianing | Expansion |
| Sample | (mAh) | rate (%) | rate (%) |
| Example 53 | 49 | 83 | 320 |
| Example 54 | 49 | 90 | 330 |
| Example 55 | 48 | 89 | 318 |
| Example 56 | 49 | 86 | 326 |
| Example 57 | 49 | 84 | 333 |
| Example 58 | 45 | 90 | 279 |
| Example 59 | 42 | 89 | 240 |
| Comparative | 51 | 12 | — |
| Example 5 | | | |
| Comparative | 50 | 33 | 362 |
| Example 6 | | | |

As shown in Table 10, in Comparative Examples 5 and 6 in which protrusions were not formed on the surface of the current collector, the capacity maintaining rate was as low as 33% or less. Furthermore, after 100 cycles of charging and discharging, when the batteries of Comparative Examples 5 and 6 were diassembled and the surface of the negative electrode was observed, a region was seen in which copper of the current collector is exposed in a place on which Si film should be formed. Furthermore, it was confirmed that fine Si particles also were floating in electrolyte and that breaking or peeling occurred due to the expansion or shrinkage during charging/discharging.

On the contrary, in Examples 53 to 59, the expansion rate was lowered and the capacity maintaining rate was improved significantly.

When the batteries in Examples 53 to 59 were diassembled after 100 cycles of charging and discharging and the surface of the negative electrode was observed through SEM, it was confirmed that the thin film formed of electrode material was expanded along the protrusion portion of the current collector. However, it is thought that even in a case where such expansion occurs, with the protrusion, the current collecting property can be secured and the properties of the batteries can be maintained.

### Comparative Examples 7 to 9

Next, Comparative Examples 7 to 9 will be described. The current collector of Comparative Example 7 produced by the following technique was used. First, a punching process was carried out with respect to the rolled copper foil (thickness: 14 μm) and current collector provided with a plurality of through holes in a lattice on the foil surface. At this time, the diameter of the through hole was made 3 mm and the pitch of the through hole was made 5 mm. For the current collector of Comparative Example 8, the current collector having the same protrusion as in the current collector 100 (see FIG. 9) described in the “Background of the invention” was used. The protrusions were formed by punching two sides with one side (corresponding to 101a in FIG. 9) unpunched so that the protrusion were protruded in a shape of a regular triangle having a side of 25 μm on the rolled copper foil used in Comparative Example 7. A plurality of protrusions were provided in a lattice on the foil. Note here that the pitch of protrusions was 100 μm. For the current collector of Comparative Example 9, the same current collector as those in Comparative Example 8 except that the shape of the protrusion was different was used. The protrusion of the current collector in Comparative Example 9 has a rectangular shape having a size of 10 μm×50 μm protruded with one of the short sides (10 μm) not protruded.

Subsequently, the slurry used in Example 1 was coated on each of the current collector by using a knife coater so that the thickness of the mixture after dried was about 70 μm. After coating, the mixture was dried by blowing in the air of 60° C., and thus a negative electrode plate was produced. This negative electrode plate was punched in a diameter of 55 mmΦ for use in a coin type battery.

The properties of the batteries of Comparative Examples 7 to 9 are shown in Table 11, respectively.

TABLE 11

| | Battery | capacity | Expansion |
|---|---|---|---|
| | capacity | maintaining | rate |
| Sample | (mAh) | rate (%) | (%) |
| Comparative | 43 | 32 | 193 |
| Example 7 | | | |
| Comparative | 43 | 40 | 195 |
| Example 8 | | | |
| Comparative | 43 | 55 | 172 |
| Example 9 | | | |

As shown in Table 11, batteries in Comparative Examples 7 to 9 have higher expansion rate as compared with those of Examples 1 to 11 and the capacity maintaining rate became lower. Furthermore, when the batteries in Comparative Examples 7 to 9 were diassembled and electrode was analyzed, it was confirmed that the electrode including an entire structure of the current collector was destroyed. This can be estimated that the current collector was broken due to cracks from the through hole formed on the current collector by the expansion stress by the active material.

### Examples 60 to 70 and Comparative Examples 10 to 12

Cylindrical batteries (Examples 60 to 70) were produced by using the negative electrodes used in Examples 1 to 11. Furthermore, as Comparative Examples, cylindrical batteries (Comparative Examples 10 to 12) were produced by using the negative electrodes used in Comparative Examples 1 to 3. Note here that positive electrode, separator and electrolyte the same as those in Example 1, were used for production.

(Method for Producing Cylindrical Batteries)

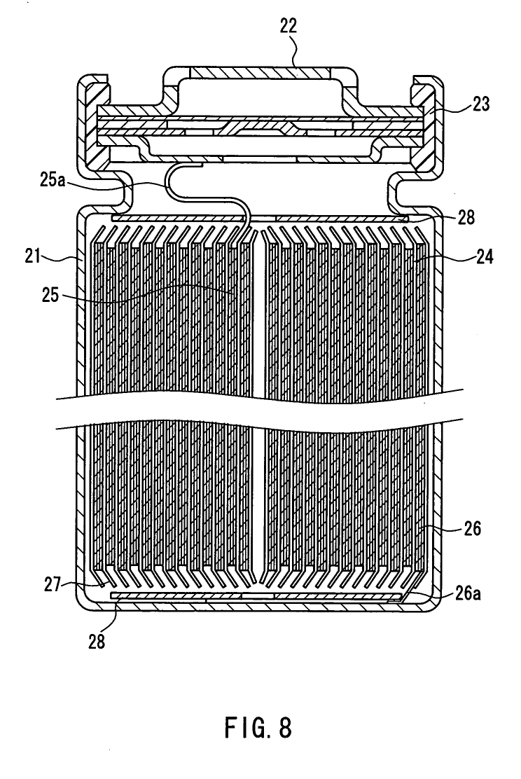

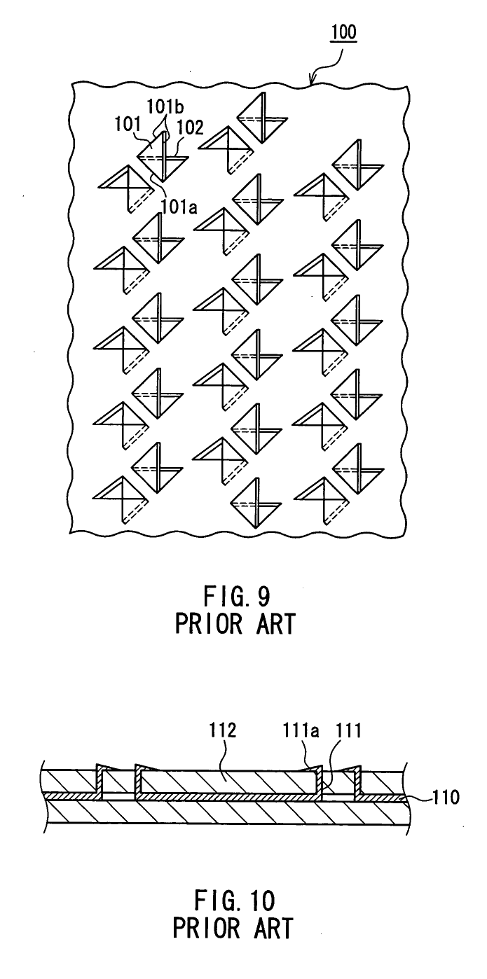

The method for producing cylindrical batteries with reference to FIG. 8 will be described. In the method for production, firstly, a positive electrode 25 having a positive lead 25a (made of aluminum) attached by ultrasonic welding and a negative electrode 26 having a negative lead 26a (made of nickel) attached by spot welding were wound spirally with a separator 24 (polyethylene separator, thickness: 27 μm) having a band shape that is wider than both electrode plates interposed therebetween. At this time, setting was carried out so that the end portion 27 of the separator 24 was beyond both electrode plates. Furthermore, the winding operation was carried out while winding the electrode group around a stainless steel rod with diameter of 3 mmΦ. Then, on the upper side and lower side of the wound electrode, an insulating plate 28 made of polypropylene was disposed, inserted into a negative electrode can 21 and electrolytic solution was injected into the upper portion of the negative electrode can 21 and sealed with a sealing plate 22 provided with a gasket 23. By the production method, 20 the cylindrical batteries were produced with the respective negative electrodes. At this time, the numbers of batteries in which the active materials peel off at the time of winding are shown in Table 12, respectively. Furthermore, with respect to the batteries in which the active materials do not peel off at the time of winding, the internal short circuit was tested. The number of batteries in which short circuit occurred is shown in Table 12.

TABLE 12

| | number | number of batteries |
|---|---|---|
| | of batteries in which | in which internal |
| Sample | active materials peel off | short circuit occurs |
| Example 60 | 0 | 1 |
| Example 61 | 0 | 0 |
| Example 62 | 0 | 1 |
| Example 63 | 0 | 0 |
| Example 64 | 0 | 0 |
| Example 65 | 0 | 0 |
| Example 66 | 0 | 0 |
| Example 67 | 0 | 0 |
| Example 68 | 0 | 1 |
| Example 69 | 0 | 0 |
| Example 70 | 0 | 0 |
| Comparative | 16 | 4 |
| Example 10 | | |
| Comparative | 14 | 4 |
| Example 11 | | |
| Comparative | 13 | 5 |
| Example 12 | | |

As shown in Table 12, in Examples 60 to 70, at the time of winding, in no batteries, active material was peeled off.

On the other hand, in Comparative Examples 10 to 12, half or more of batteries, active materials peeled off. Furthermore, in almost all the batteries in which active materials do not peel off, internal short circuit occurs. This is thought because cracks occurred due to the stress received at the time of winding and when the electrolytic solution was injected and the active material peeled off from the current collector, so that the internal short circuit occurred.

### Examples 71 to 73 and Comparative Example 13

As a core material of the current collector used in Examples 71 to 73, those formed by providing protrusion made of polypropylene which were respectively formed in a mushroom shape (see FIG. 4A) (Example 71), a hook shape (see FIG. 4G) (Example 72) and a cauliflower shape (see FIG. 4K) (Example 73) were prepared. Specifically, on a polypropylene film having a thickness of 15 μm, protrusion formed by processing polypropylene was transferred and attached. In the case of the mushroom shape (Example 71), the protrusion was formed so that the average height was 30 μm, maximum height was 40 μm, column width was 7 μm and width of umbrella was 20 μm. In the case of the hook shape (Example 72), the protrusion was formed so that the average height was 45 μm, maximum height was 50 μm, column width was 8 μm and maximum width of hook was 28 μm. In the case of the cauliflower shape (Example 73), the protrusion was formed so that the average height was 35 μm, maximum height was 40 μm, column width was 10 μm and maximum width 30 μm. Note here that the number of protrusions was about 5000 per 1 cm² of polypropylene film. Furthermore, as a core material of the current collector used in Comparative Example 13, polypropylene film (thickness: 20 μm) in which the protrusions were not formed was prepared.

Each of the polypropylene film was made to be hydrophobic by plasma processing techniques and a copper layer (conductor layer) was formed on the surface of the polypropylene film by electroless copper plating. At this time, the average thickness of the copper layer was controlled so as to be 1.5 μm.

With respect to these samples, the mixture was coated by using a knife coater so that the thickness of the mixture after dried was about 70 μm. After coating, the mixture was dried by blowing in the air of 60° C., and thus a negative electrode plate was produced. This negative electrode plate was punched in a diameter of 55 mmΦ for use in a coin type battery.

The properties of the batteries were evaluated and the results are shown in Table 13, respectively.

TABLE 13

| | | battery | capacity maintaining | Expansion |
|---|---|---|---|---|
| | shape of | capacity | rate | rate |
| Sample | protrusion | (mAh) | (%) | (%) |
| Example71 | mushroom | 42 | 94 | 115 |
| Example72 | hook | 41 | 93 | 113 |
| Example73 | cauliflower | 41 | 95 | 114 |
| Comparative | — | 43 | 52 | 190 |
| Example 13 | | | | |

As shown in Table 13, in Examples 71 to 73, a low expansion rate and high capacity maintaining rate could be realized. On the other hand, in Comparative Example 13, the expansion rate was increased and the capacity maintaining rate was lowered. Furthermore, when the battery of Comparative Example 13 was diassembled, it was confirmed that the active material was peeled off from the current collector. From the results as mentioned above, according to the present invention, it was shown that it was possible to prevent electrode materials from peeling off from the current collector and to improve the capacity maintaining rate. Note here that in this Example, the conductor layer was formed by electroless plating. However, the conductor layer also can be formed by, for example, a CVD method or a vapor deposition method. The same results were obtained in this case.

The present invention could provide a negative electrode for a non-aqueous electrolyte secondary battery and non-aqueous electrolyte secondary battery, which have high properties such as energy density, charging/discharging cycle property. Furthermore, the non-aqueous electrolyte secondary battery of the present invention can be used for wide applications of use, for example, portable equipment such as a notebook computer, a portable telephone, digital video camera, digital camera, or transportation equipment.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. A negative electrode for a non-aqueous electrolyte secondary battery capable of reversibly absorbing and desorbing Li ions, the negative electrode comprising:
a current collector; and
an electrode material layer comprising an electrode material capable of reversibly absorbing and desorbing Li ions;
wherein the electrode material comprises at least one element selected from the group consisting of Si, Sn and Al;
the surface of the current collector is provided with protrusions;
the electrode material layer is disposed on the surfaces of the current collector and the protrusions; and
the protrusion has a portion facing the surface of the current collector other than a portion that is brought into contact with the current collector.

2. The negative electrode for a non-aqueous electrolyte secondary battery according to claim 1, wherein the protrusion has a portion whose cross-sectional area cut in the direction parallel to the surface of the current collector exceeds an area of a portion that is brought into contact with the current collector.

3. The negative electrode for a non-aqueous electrolyte secondary battery according to claim 1, wherein the protrusion has at least one shape selected from the group consisting of a zigzag shape and an undulated shape.

4. The negative electrode for a non-aqueous electrolyte secondary battery according to claim 1, wherein the average height of the protrusion from the surface of the current collector is 15% or more and 75% or less with respect to the thickness of the electrode material layer.

5. The negative electrode for a non-aqueous electrolyte secondary battery according to claim 1, wherein the maximum height of the protrusion from the surface of the current collector is 95% or less with respect to the thickness of the electrode material layer.

6. The negative electrode for a non-aqueous electrolyte secondary battery according to claim 1,
wherein the protrusion comprises a column portion linked to the surface of the current collector; and a covering portion linked to the end of the column portion opposite side to the current collector; and
wherein the covering portion has a portion whose cross-sectional area cut in the direction parallel to the surface of the current collector exceeds the cross-sectional area of the column portion cut in the direction parallel to the surface of the current collector.

7. The negative electrode for a non-aqueous electrolyte secondary battery according to claim 6, wherein the protrusion has a plurality of the covering portions.

8. The negative electrode for a non-aqueous electrolyte secondary battery according to claim 1, wherein the protrusion, when cut in the direction perpendicular to the surface of the current collector, has at least one shape selected from the group consisting of a mushroom shape, an umbrella shape, a nail head shape, a laterally-facing L-shape, a reverse J-shape, a hook shape, a T-shape, a Y-shape, a screw shape, a cauliflower shape and a pile shape.

9. The negative electrode for a non-aqueous electrolyte secondary battery according to claim 1, wherein the protrusion comprises a conductive material.

10. The negative electrode for a non-aqueous electrolyte secondary battery according to claim 1, wherein the protrusion comprises a metallic particle.

11. The negative electrode for a non-aqueous electrolyte secondary battery according to claim 10, wherein the metallic particle comprises at least one element selected from the group consisting of Cu, Ni and Ti.

12. The negative electrode for a non-aqueous electrolyte secondary battery according to claim 1, wherein the protrusion comprises a metallic fiber.

13. The negative electrode for a non-aqueous electrolyte secondary battery according to claim 1, wherein the current collector comprises a metallic fiber, and the protrusion has a pile shape formed by raising the metallic fiber.

14. The negative electrode for a non-aqueous electrolyte secondary battery according to claim 13, wherein the metallic fiber comprises at least one selected from the group consisting of Cu, Ni, and stainless steel.

15. The negative electrode for a non-aqueous electrolyte secondary battery according to claim 1, wherein the electrode material is a powder form having a maximum particle size of 0.01 μm or more and 45 μm or less.

16. The negative electrode for a non-aqueous electrolyte secondary battery according to claim 1, wherein the electrode material has a form of a thin film.

17. The negative electrode for a non-aqueous electrolyte secondary battery according to claim 1,
wherein the current collector comprises a macromolecular film and a conductor layer; the surface of the macromolecular film is provided with the protrusions; and the conductor layer is formed along the surface shape of the macromolecular film.

18. The negative electrode for a non-aqueous electrolyte secondary battery according to claim 17, wherein the macromolecular film is a polyolefin film.

19. The negative electrode for a non-aqueous electrolyte secondary battery according to claim 17, wherein the conductor layer comprises at least one element selected from the group consisting of Cu, Ni and Ti.

20. A non-aqueous electrolyte secondary battery, comprising:
a negative electrode for a non-aqueous electrolyte secondary battery, which is capable of reversibly absorbing and desorbing Li ions;
a positive electrode capable of reversibly absorbing and desorbing Li ions; and
an electrolyte having a Li ion conductivity;
wherein the negative electrode comprises a current collector, and an electrode material layer comprising an electrode material capable of reversibly absorbing and desorbing Li ions;
the electrode material comprises at least one element selected from the group consisting of Si, Sn and Al;
the surface of the current collector is provided with protrusions;
the electrode material layer is disposed on the surfaces of the current collector and the protrusions; and
the protrusion has a portion facing the surface of the current collector other than a portion that is brought into contact with the current collector.
